(19) United States
(12) Patent Application Publication
(10) Pub. No.: US 2014/0052863 A1
(43) Pub. Date: Feb. 20, 2014

(54) Node Address Allocation

(71) Applicant: Control Techniques Limited, Newtown (GB)

(72) Inventor: Simon David Hart, Welshpool (GB)

(73) Assignee: Control Techniques Limited, Newtown (GB)

(21) Appl. No.: 13/970,123

(22) Filed: Aug. 19, 2013

(30) Foreign Application Priority Data
Aug. 20, 2012 (GB) 1214859.9

(51) Int. Cl. H04L 29/08

(52) U.S. Cl. CPC H04L 67/12
USPC 709/226

(57) ABSTRACT

There is provided a method for allocating node addresses in a computer network architecture and a computer network architecture for performing such a method. The computer network architecture comprises at least one master node and at least one slave node serially connected downstream of the master node. Each slave node includes a switch for connecting an upstream transmit line with a downstream transmit line at the slave node. When the switch is open, the master node and any upstream slave nodes are not connected via the transmit line to any downstream slave nodes. When the switch is closed, the master node and any upstream slave nodes are connected via the transmit line to any downstream slave nodes.

### CROSS-REFERENCE TO RELATED APPLICATION

This application claims the benefit and priority of Great Britain Patent Application No. 1214859.9 filed Aug. 20, 2012. The entire disclosure of the above application is incorporated herein by reference.

### FIELD

The present disclosure relates to a method for allocating node addresses in a computer network architecture and a computer network architecture for performing such a method.

### BACKGROUND

In a computer network, data is transmitted between network nodes, which may be network devices or circuit boards. The network nodes may be coupled by network media such as coaxial cable or twisted-pair wiring, or the network nodes may be wirelessly connected.

FIG. 1 shows one serial communication network according to the prior art. In the network of FIG. 1, master node 100 and slave nodes 101 to 10n are connected via two signal lines 105 (serial data) and 107 (serial clock). In order for a master node device to access a slave node device, a slave address must be allocated to each slave node. For example, in FIG. 1, each of the slave nodes 101, 102, . . . , 10n has an address modified by one bit: “1010 000” allocated to 101, “1010 001” allocated to 102, and so on. Addresses need to be allocated before data can be sent between master and slave nodes, either upon activation of a network or when a new slave node is added to an existing network.

An improved method and network for slave node address allocation is described herein.

### SUMMARY

An invention is set out in the claims.

According to a first aspect, there is provided a method for allocating node addresses in a computer network architecture comprising at least one master node and at least one slave node serially connected downstream of the master node, the or each slave node including a switch for connecting an upstream transmit line with a downstream transmit line at the slave node such that, when the switch is open, the master node and any upstream slave nodes are not connected via the transmit line to any downstream slave nodes and, when the switch is closed, the master node and any upstream slave nodes are connected via the transmit line to any downstream slave nodes, wherein, before the method is performed: at least one of the slave nodes has not yet been allocated a unique slave address; any slave nodes not yet allocated a unique slave address share a default slave address; and the switch in any slave node having the default slave address is open, the method comprising the steps of: a) the master node sending a message on the default slave address; b) the furthest upstream slave node having the default slave address being allocated a unique slave address; c) the slave node allocated the unique slave address at step b) closing the switch connecting the upstream transmit line with the downstream transmit line, so as to connect the master node and any upstream slave nodes to any downstream slave nodes; d) the slave node allocated the unique slave address at step b) sending an acknowledgement to the master node; and e) if there are any further slave nodes having the default slave address, repeating steps a) to d) for each such slave node.

The method provides an improved method of node address allocation. The method is straightforward and fast. The method is controlled by the master node. The method guarantees the correct connection strategy for slave nodes, particularly when there are other signals on the connection lines between the master and slave nodes. A common transmit line is provided for broadcasts and commands.

The message sent by the master node may include an instruction to allocate the unique slave address to the message recipient and step b) comprises the furthest upstream slave node having the default slave address actioning the message. Alternatively, the instruction to allocate the unique slave address may be sent separately, or the slave node may automatically take the unique slave address on receipt of a message on the default slave address.

The method may further include, after step a), the step of the furthest upstream slave node having the default address, acknowledging the message. The acknowledgement may be sent to the master node on a receive line between the slave node and the master node.

Alternatively, the acknowledgement sent by the slave node to the master node at step d) may comprise an acknowledgement that the unique slave address has been allocated and that the upstream and downstream transmit lines have been connected. Thus, a separate acknowledgement after step a) may not be necessary. The acknowledgement at step d) may be sent to the master node on a receive line between the slave node and the master node.

In one embodiment, step c) is performed automatically after the slave node has been allocated the unique slave address at step b). This is quick and straightforward. In one embodiment, the message includes an instruction to connect the upstream transmit line at the message recipient with the downstream transmit line at the message recipient, after the slave node has been allocated the unique slave address. The message may include an instruction to allocate a unique slave address to the message recipient and an instruction to connect the upstream and downstream transmit lines at the message recipient. In another embodiment, step c) is performed in response to a second message from the master node. The second message is sent on the unique slave address.

Step e) may comprise the master node periodically checking if there are any further slave nodes having the default slave address. Step e) may comprise the master node sending out a message on the default slave address. Step e) may comprise the master node observing a break in communication with one or more downstream slave nodes and concluding that the break in communication is due to a slave node still taking the default slave address.

The at least one master node and the at least one slave node may be connected via a receive line for communication in the direction from the slave nodes towards the master node. Thus, communication in the direction from the master node towards the slave nodes is on the transmit line and communication in the opposite direction is on the receive line. The receive line can be used for synchronised message returns and time multiplexed data returns. According to an embodiment, if an acknowledgement of the message is sent to the master node, the acknowledgement is sent on the receive line. According to an embodiment, the acknowledgement of step d) is sent on the receive line.

In one embodiment, before the method is performed, all slave nodes have not yet been allocated unique slave addresses. Steps a) to e) are therefore repeated for every slave node, until all slave nodes have been allocated unique slave addresses. The method may be used before there is any communication between master and slave nodes, for example, upon initial activation of the network.

In another embodiment, before the method is performed, at least one of the slave nodes has already been allocated a unique slave address. Steps a) to e) are therefore repeated only for the slave node or nodes which have not yet been allocated a unique slave address and have the default slave address. Steps a) to e) are repeated until all slave nodes have been allocated unique slave addresses. The method may be used to add new slave nodes into an existing network.

According to a second aspect, there is provided a computer network architecture comprising: at least one master node; at least one slave node serially connected downstream of the master node; and a transmit line connecting the at least one master node and the at least one slave node, the transmit line for communication in the downstream direction; wherein each slave node includes a switch for connecting the upstream transmit line with the downstream transmit line at the slave node; wherein the computer network architecture is arranged such that, when a slave node has not yet been allocated a unique slave address, the slave node takes a default slave address common to all slave nodes not yet allocated unique slave addresses, and the switch in the slave node is open such that the master node and any upstream slave nodes are not connected via the transmit line to any downstream slave nodes; and when a slave node has been allocated a unique slave address, the switch in the slave node is closed such that the master node and any upstream slave nodes are connected via the transmit line to any downstream slave nodes.

The computer network architecture allows slave nodes to be allocated node addresses in an improved manner. The slave nodes are serially connected. According to an embodiment, there is a single transmit line for both communications and power signals. Any message sent from the master node on the default slave address will be actioned by only the furthest upstream slave node having the default slave address, because that slave node's switch is open, preventing connection to any downstream slave nodes also having the default slave address. Thus, if the master node sends a message on the default slave address, the message including an instruction to allocate a unique slave address to the first message recipient, the unique slave address will be allocated only to the furthest upstream slave node having the default slave address. If the master node subsequently sends a message on the unique slave address, the message will be actioned by the slave node which has just been allocated the unique slave address. If the message includes an instruction to connect the upstream transmit line with the downstream transmit line, the slave node which has just been allocated the unique slave address will close the switch to connect the upstream transmit line with the downstream transmit line. This allows further downstream slave nodes to be addressed via the default slave address.

The computer network architecture may further comprise a receive line connecting the at least one master node and the at least one slave node, the receive line for communication in the upstream direction. Thus, communication in the direction from the master node towards the slave nodes is on the transmit line and communication in the opposite direction is on the receive line. The receive line can be used for synchronised message returns and time multiplexed data returns.

The or each slave node may further comprise an adder connected to the receive line. The adder allows the slave node to receive data from downstream on the receive line, add data, and send the combined data upstream. According to an embodiment, any slave node only responds to the master node once it has a unique slave address and only if the master node addresses the slave node. Thus, in such an embodiment, slave nodes can add data to the receive line only when addressed by the master node. According to an embodiment, if the master node message requires a response, the master node only addresses one slave node at a time. Messages not requiring a response may be broadcast to all slave nodes.

The or each slave node may further comprise a processor connected to the transmit line for receiving and processing data from the master node.

According to a third aspect, there is provided a computer network architecture for carrying out the method of the first aspect.

According to a fourth aspect, there is provided a slave node for the computer network architecture of the third or the fourth aspect.

Features described in relation to one aspect, may also be applicable to another aspect.

### DRAWINGS

A prior art arrangement has already been described with reference to accompanying FIG. 1. Embodiments will now be further described, by way of example only, with reference to accompanying FIGS. 2 to 7, in which:

FIG. 2 shows a computer network before node address allocation according to a first embodiment;

FIG. 3 shows the computer network of FIG. 2 during a first step of node address allocation;

FIG. 4 shows the computer network of FIGS. 2 and 3 during a second step of node address allocation;

FIG. 5 shows a computer network according to a second embodiment;

FIG. 6 shows a computer network according to a third embodiment; and

FIG. 7 is a flow chart showing a method of address allocation according to an embodiment.

### DETAILED DESCRIPTION

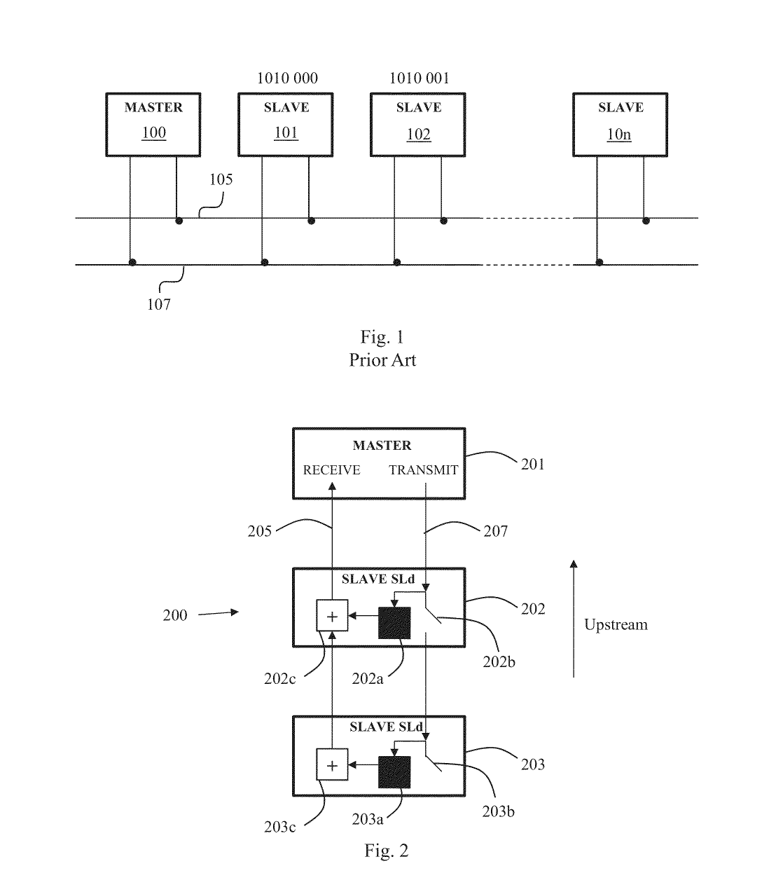

FIG. 2 shows a computer network according to a first embodiment. FIG. 2 shows the network before slave node addresses have been allocated. In the embodiment of FIG. 2, computer network 200 comprises master node 201 and two slave nodes 202, 203. Only two slave nodes are shown in FIG. 2 for the sake of simplicity, but any number of slave nodes may be included in the computer architecture. Slave nodes 202 and 203 are connected in series downstream of master node 201. In the embodiment of FIG. 2, each node is connected in series by two single-direction communication lines: receive line 205 for communication in the upstream direction (from slave nodes towards master node), and transmit line 207 for communication in the downstream direction (from master node towards slave nodes).

In FIG. 2, the upstream transmit line 207 in each slave node 202, 203 is connected to a processor (shown as black box 202a in slave node 202, and black box 203a in slave node 203) for receiving and processing data from master node 201. Each slave node 202, 203 also comprises a switch 202b, 203b connected to the transmit line 207 for connecting the upstream transmit line to the downstream transmit line and hence to further downstream slave node or nodes. Each slave node 202, 203 also includes an adder 202c, 203c connected to the receive line 205.

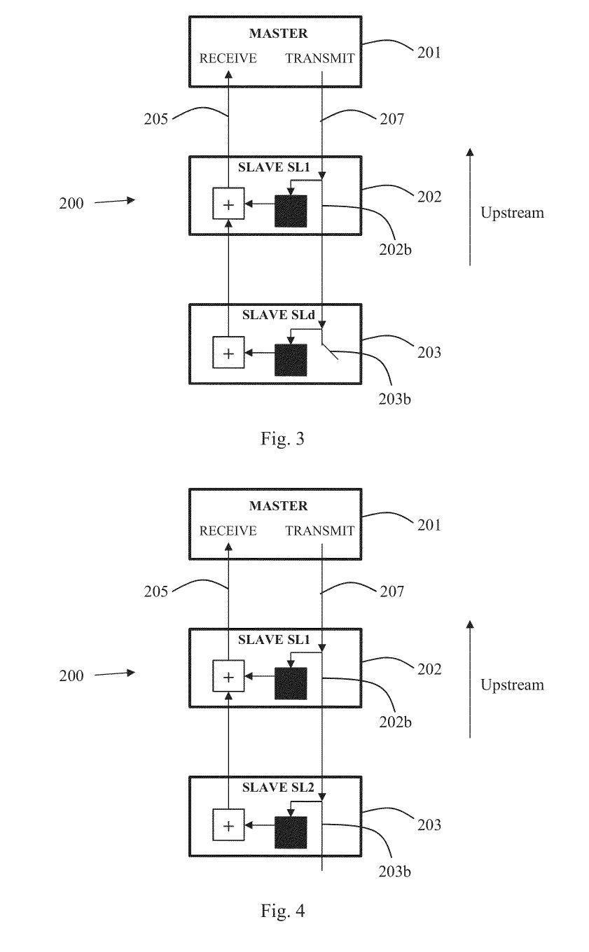

In order for master node 201 to access a slave node, a unique slave address must be allocated to the slave node. FIG. 2 shows the computer network architecture 200 before unique slave addresses have been allocated to either slave node 202, 203. Because the slave nodes 202, 203 have not yet been allocated unique addresses, the switches 202b, 203b are open, so that the upstream transmit line at each slave node is not connected to the downstream transmit line. Slave nodes 202, 203 have not yet been allocated unique addresses and, as shown in FIG. 2, both slave nodes 202, 203 take the same default address SLd. If additional slave nodes were included in the computer network 200, all slave nodes would share the same default address SLd at this stage. A process of node address allocation will now be described with reference to FIGS. 3 and 4. FIG. 3 shows the computer network of FIG. 2 at a first stage during node address allocation, and FIG. 4 shows the computer network of FIG. 2 at a second stage during node address allocation.

Referring again to FIG. 2, first, master node 201 sends a message on default address SLd. This message is actioned only by slave node 202 which is the furthest upstream slave node. Because switch 202b is open, any slave nodes downstream of slave node 202 (in this embodiment, slave node 203 only) are not connected. Thus, even though slave node 203 currently has the same default address SLd as slave node 202, slave node 203 does not action the message from master node 201. In this embodiment, the message from master node 201 instructs allocation of a unique slave address SL1. Because the message is actioned only by slave node 202, slave node 202 is now allocated unique slave address SL1. The slave node 202 may acknowledge receipt of the unique slave address SL1 by sending a receipt to master node 201.

After slave node 202 has been allocated its unique slave address SL1, slave node 202 closes switch 202b, which connects the upstream transmit line at slave node 202 to the downstream transmit line at slave node 202. This may be performed automatically, on receipt of unique slave address SL1. Alternatively, the message from master node 201 instructing allocation of a unique slave address may also instruct closure of switch 202b. Alternatively, switch 202b may be closed in response to a second message from master node 201, this time on unique slave address SL1. This is shown in FIG. 3, which illustrates switch 202b closed and slave node 202 allocated unique address SL1. The slave node 202 may now respond to master node 201 to confirm that the upstream and downstream transmit lines at slave node 202 are connected. Alternatively, rather than send two separate acknowledgements, the slave node 202 may send a single acknowledgement once both unique address SL1 is allocated and switch 202b is closed.

The master node 201 then sends another message on default address SLd. This message is actioned only by slave node 203 which is the furthest upstream slave node still allocated the default address SLd, because slave node 202 has already been allocated its own unique address SL1. Because switch 203b is open, any slave nodes downstream of slave node 203 (none in this embodiment) are not connected. Thus, even though any further downstream slave nodes would currently have the same default address SLd as slave node 203, they do not action the message from master node 201. In this embodiment, the message from master node 201 instructs allocation of a second unique slave address SL2. Because the message is actioned only by slave node 203, slave node 203 is now allocated unique slave address SL2. The slave node 203 may now acknowledge receipt of the unique slave address SL2 by sending a receipt to master node 201.

After slave node 203 has been allocated its unique slave address SL2, slave node 203 closes switch 203b, which connects the upstream transmit line at slave node 203 to the downstream transmit line at slave node 203. This may be performed automatically, on receipt of unique slave address SL2. Alternatively, the message from master node 201 instructing allocation of a unique slave address may also instruct closure of switch 203b. Alternatively, switch 203b may be closed in response to a message from master node 201 on unique slave address SL2. This is shown in FIG. 4, which illustrates switch 203b closed and slave node 203 allocated unique address SL2. The slave node 203 may now respond to master node 201 to confirm that the upstream and downstream transmit lines at slave node 203 are connected. Alternatively, rather than send two separate acknowledgements, the slave node 203 may send a single acknowledgement once both unique address SL2 is allocated and switch 203b is closed.

If further downstream slave nodes are included in the computer architecture, the cycle repeats until each slave node has been allocated a unique slave address.

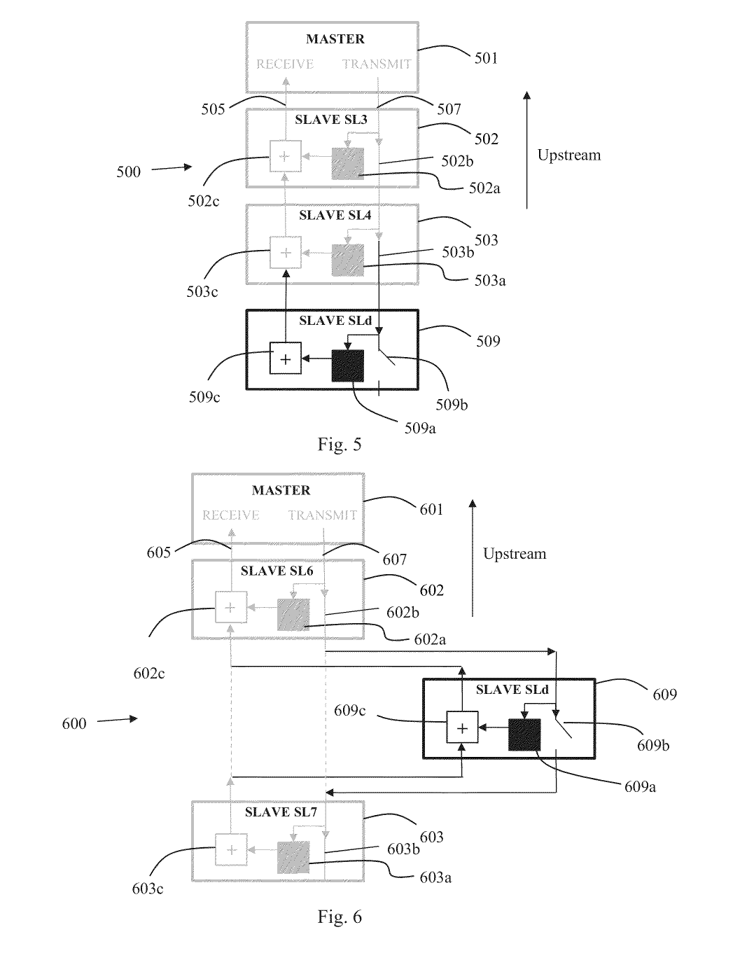

In the embodiment described with reference to FIGS. 2, 3 and 4, at the outset, none of the slave devices have been allocated unique addresses and all slave devices share the same default slave address. All slave nodes must be addressed before there can be any communication or data exchange between master and slaves. However, the method of node address allocation described herein may also be used when an additional slave device is to be added to a network in which the other slave devices already have allocated unique slave addresses. In this case, the master node may periodically test for new slave nodes, and then uniquely address any which still take the default slave address. This will be described with reference to FIGS. 5 and 6.

FIG. 5 shows a computer network according to a second embodiment. As in FIGS. 2, 3 and 4, in FIG. 5, computer network 500 comprises master node 501 and two slave nodes 502, 503. Slave nodes 502, 503 are connected in series downstream of master node 501. In the embodiment of FIG. 5, each node is connected in series by two single-direction communication lines: receive line 505 for communication in the upstream direction, and transmit line 507 for communication in the downstream direction. Slave nodes 502 and 503 have the same structure as slave nodes 202 and 203 in FIGS. 2, 3 and 4. That is, slave nodes 502, 503 include a processor (shown as black box 502a in slave node 502, and black box 503a in slave node 503) connected to the upstream transmit line 507, a switch (502b in slave node 502, 503b in slave node 503) also connected to the upstream transmit line 507, and an adder (502c in slave node 502 and 503c in slave node 503) connected to the receive line 505.

In order for master node 501 to access a slave node, a unique slave address must be allocated to the slave node. In FIG. 5, slave node 502 has already been allocated unique slave address SL3 and slave node 503 has already been allocated unique slave address SL4. Because slave nodes 502 and 503 have already been allocated unique addresses, these nodes are shown in grey in FIG. 5. Because slave nodes 502 and 503 have already been allocated unique addresses, switches 502b and 503b are closed, so that the upstream transmit line at each slave node is connected to the downstream transmit line.

Further slave node 509 is now to be added to the network 500. For example, slave node 509 may be a further circuit board or network device added for network modification or improvement. New slave node 509 is shown in black. Slave node 509 has the same general form as slave nodes 502 and 503 and includes a processor (black box 509a), a switch 509b, and an adder 509c. Slave node 509 is to be added downstream of slave nodes 502 and 503. Slave node 509 does not yet have a unique slave address and currently takes default slave address SLd. Switch 509b is therefore open.

First, master node 501 sends a message on default address SLd. This is actioned only by slave node 509 which is the furthest upstream (and in this case the only) slave node still allocated the default address SLd, because slave nodes 502 and 503 already have unique slave addresses. Because switch 509b is open, any additional slave nodes downstream of slave node 509 are not connected. Thus, any further new downstream slave nodes (none of which are shown in FIG. 5) do not action the message even though they currently have the same default address SLd. In this embodiment, the message from master node 501 instructs allocation of a unique slave address SL5. Because the message is actioned by slave node 509, slave node 509 is now allocated unique slave address SL5. The slave node 509 may acknowledge receipt of the unique slave address SL5 by sending a receipt to master node 501.

After slave node 509 has been allocated its unique slave address SL5, slave node 509 closes switch 509b, which connects the upstream transmit line at slave node 509 to the downstream transmit line at slave node 509. This may be performed automatically, on receipt of unique slave address SL5. Alternatively, the message from master node 509 instructing allocation of a unique slave address may also instruct closure of switch 509b. Alternatively, switch 509b may be closed in response to a message from master node 501 on unique slave address SL5 instructing the recipient slave node to connect its upstream and downstream transmit lines. Closure of switch 509b connects the master node and upstream slave nodes to any downstream slave nodes. If further downstream slave nodes are to be added to the computer architecture, the cycle repeats until each new slave node has been allocated a unique address.

FIG. 6 shows a computer network according to a third embodiment. As in FIGS. 2, 3, 4 and 5, in FIG. 6, computer network 600 comprises master node 601 and two slave nodes 602, 603. Slave nodes 602, 603 are connected in series downstream of master node 601. In the embodiment of FIG. 6, each node is connected in series by two single-direction communication lines: receive line 605 for communication in the upstream direction, and transmit line 607 for communication in the downstream direction. Slave nodes 602 and 603 have the same structure as slave nodes 202, 203, 502 and 503. That is, slave nodes 602, 603 include a processor (shown as black box 602a in slave node 602, and black box 603a in slave node 603) connected to the upstream transmit line 607, a switch (602b in slave node 602, 603b in slave node 603) also connected to the upstream transmit line 607, and an adder (602c in slave node 602 and 603c in slave node 603) connected to the receive line 605.

In order for master node 601 to access a slave node, a unique slave address must be allocated to the slave node. In FIG. 6, slave node 602 has already been allocated unique slave address SL6 and slave node 603 has already been allocated unique slave address SL7. Because slave nodes 602 and 603 have already been allocated unique addresses, these nodes are shown in grey in FIG. 6. The connections between them are shown in grey dotted lines. Because slave nodes 602 and 603 have already been allocated unique addresses, switches 602b and 603b are closed, so that the upstream transmit line at each slave node is connected to the downstream transmit line.

Further slave node 609 is now to be added to the network 600. For example, slave node 609 may be a further circuit board or network device added for network modification or improvement. New slave node 609 is shown in black. Slave node 609 has the same general form as slave nodes 602 and 603 and includes a processor (black box 609a), a switch 609b, and an adder 609c. Slave node 609 is to be added between slave nodes 602 and 603. Slave node 609 does not yet have a unique slave address and currently takes default slave address SLd. Switch 609b is therefore open.

First, master node 601 sends a message on default address SLd. This is actioned only by slave node 609 which is the furthest upstream (and in this case the only) slave node still allocated the default address SLd, because slave nodes 602 and 603 already have unique slave addresses. Because switch 609b is open, slave node 603 and any additional slave nodes downstream of slave node 609 are not connected. Thus, any further new downstream slave nodes do not action the message even though they currently have the same default address SLd. In this embodiment, the message from master node 601 instructs allocation of a unique slave address SL8. Because the message is actioned by slave node 609, slave node 609 is now allocated unique slave address SL8. The slave node 609 may acknowledge receipt of the unique slave address SL8 by sending a receipt to master node 601.

After slave node 609 has been allocated its unique slave address SL8, slave node 609 closes switch 609b, which connects the upstream transmit line at slave node 609 to the downstream transmit line at slave node 609. This may be performed automatically, on receipt of unique slave address SL8. Alternatively, the message from master node 609 instructing allocation of a unique slave address may also instruct closure of switch 609b. Alternatively, switch 609b may be closed in response to a message from master node 601 on unique slave address SL8 instructing the recipient slave node to connect its upstream and downstream transmit lines. Closure of switch 609b connects the master node and upstream slave node 602 to downstream slave node 603 and any other downstream slave nodes. If further downstream slave nodes are to be added to the computer architecture, the cycle repeats until each new slave node has been allocated a unique address.

In the case of FIGS. 5 and 6, where the method is used when an additional slave device is to be added to a network in which other slave devices already have allocated unique slave addresses, the master node may periodically test for new slave nodes, and then uniquely address any which still take the default slave address. The master node may keep a record of all slave addresses which have been allocated. In the embodiment illustrated in FIG. 6, before slave node 609 is uniquely addressed (and hence switch 609b is open), master node 601 will find that slave node 603 does not respond to any communication, which indicates a break in the connection. Master node 601 will then send a message on default slave address in order to initiate the method described herein of allocating unique slave addresses to any new slave nodes. When slave 609 has been allocated a unique slave address, switch 609b will be closed, allowing downstream slave node 603 to receive and respond to messages once again. Thus, broken connections may be detected.

The methods described with reference to FIGS. 5 and 6 could be combined. That is, new slave nodes could be added to the existing network between existing slave nodes as well downstream of existing slave nodes. In this case, the slave node or nodes between existing slave nodes is allocated a unique address first, and then that slave node closes its switch to connect the upstream and downstream transmit lines. This connects any new slave nodes further downstream, which can then also be allocated new slave addresses.

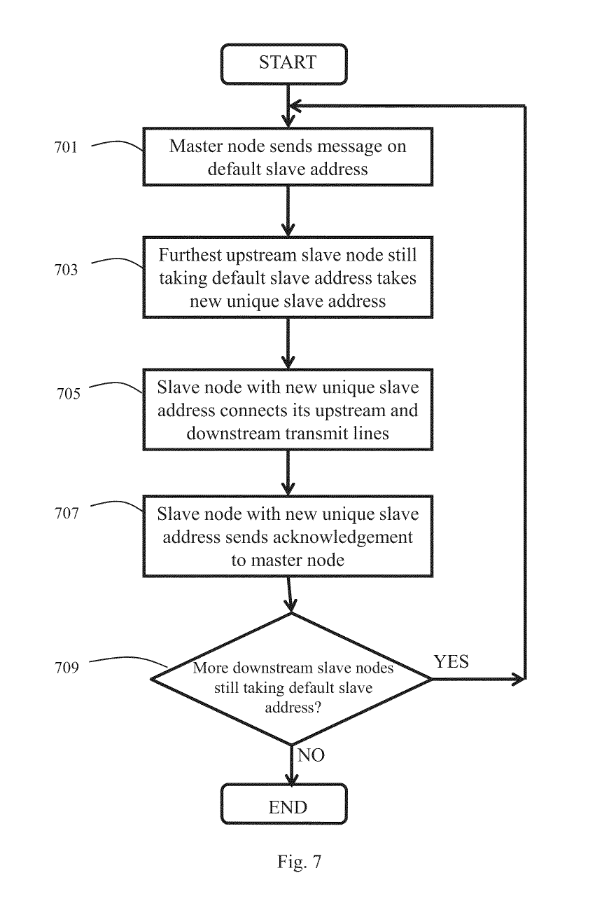

FIG. 7 is a flow chart showing a general method of node address allocation according to an embodiment, for a computer network architecture including any number of downstream slave nodes. The method may be used upon initial activation when all slave nodes initially share the default slave address. Alternatively, the method may be used to add a new slave node into an existing network, in which case all slave nodes already in the computer network have already been allocated a unique address, and only the new slave nodes share the default slave address. At first step 701, the master node sends a message on the default slave address. The message may include the instruction of a new unique slave address, although it is possible that the unique slave address is sent by a separate communication. At second step 703, the furthest upstream slave node which is still allocated the default slave address now takes the new unique slave address. If the master node message included instruction of the new unique slave address, this will comprise the furthest upstream slave node which is still allocated the default slave address actioning that message and thereby taking the new unique slave address. In the embodiment described with reference to FIGS. 2, 3 and 4, this is slave node 202 since both slave nodes 202 and 203 are yet to be allocated unique addresses. In the embodiment described with reference to FIG. 5, this is slave node 509 since slave nodes 502 and 503 have already been allocated unique addresses SL3 and SL4 respectively. In the embodiment described with reference to FIG. 6, this is slave node 609 since slave nodes 602 and 603 have already been allocated unique addresses SL6 and SL7 respectively. At this stage, the slave node may acknowledge to the master node that it now takes the unique slave address. Alternatively, that acknowledgement may be omitted or may be sent later, for example as part of the fourth step 707, described below.

At third step 705, the slave node which now has the new unique slave address connects its upstream and downstream transmit lines. This may be in response to a further message from the master node on the new unique slave address. Alternatively, this may be performed automatically once new unique slave address is allocated. Alternatively, this may be performed in response to an instruction in the original message (on the default slave address) from the master node. Accordingly, in the embodiment described with reference to FIGS. 2, 3 and 4, slave node 202 closes switch 202b, thereby connecting its upstream and downstream transmit lines. In the embodiment described with reference to FIG. 5, slave node 509 closes switch 509b, thereby connecting its upstream and downstream transmit lines. In the embodiment described with reference to FIG. 6, slave node 609 closes switch 609b, thereby connecting its upstream and downstream transmit lines.

At fourth step 707, the slave node which now has the new unique slave address acknowledges to the master node that its upstream and downstream transmit lines are connected. This confirms to the master node that there was a slave node waiting to be addressed. This also confirms that, if there are any further slave nodes still taking the default slave address, the master node can continue to allocate unique slave addresses to those slave nodes.

At fifth step 709, master node determines whether there are any further downstream slave nodes still taking the default slave address. If YES, the process repeats from step 701 so that any slave nodes which still take the default slave address are allocated unique slave addresses. If NO, the process is complete, since all slave nodes have been allocated unique slave addresses. The master node may periodically look for slave nodes that still take the default slave address, for example those which have been added after the original address allocations. In the embodiment described with reference to FIGS. 2, 3 and 4, slave node 203 still has the default slave address, so the process repeats until slave node 203 has been allocated unique slave address SL2. Once slave node 203 has been allocated unique slave address SL2, all slave nodes have been allocated unique slave addresses, so the process is complete. In the embodiment described with reference to FIG. 5, no slave nodes still have the default slave address, so the process is complete. In the embodiment described with reference to FIG. 6, no slave nodes still have the default slave address, so the process is complete.

Once unique slave addresses have been allocated to all slave nodes, the master node can access the slave nodes. Once unique slave addresses have been allocated to all slave nodes, and hence all slave nodes have connected their upstream and downstream transmit lines, the computer architecture is equivalent to each node being connected to a bus. If all slave nodes need to be reset to the original default slave address or to any other common slave address for any reason (for example, at a system reset), a broadcast message may be sent to all slave nodes, instructing all switches to be opened and all slave nodes to be allocated the default slave address or other common slave address. Although embodiments have been described wherein all slave nodes in a network are allocated unique slave addresses, the method could be used to give unique slave addresses to a limited number, or otherwise limited selection, of slave nodes in a network. The selection of slave nodes for address allocation could be automatic and/or user-controlled. The connections (in both upstream and downstream directions) could be wireless connections and the switches could be virtual switches. The computer network architecture may be used for power systems, in which nodes may include control boards, power boards and parallel interface boards.

In the described embodiments, a single line in each direction is provided for both communications and power signals: the transmit line in the downstream direction and the receive line in the upstream direction. However it is possible for the computer network architecture to include separate lines for communication signals and power signals respectively in a single direction. The master node may control the information flow by starting the transfer and maintaining a timed regular data cycle. At the beginning of each such data cycle, the master node sends out a message and awaits the return of data from one or more of the slave nodes.

According to an embodiment, there is no clock signal sent between nodes in either the upstream or the downstream direction as clock signal data is not needed in order to reliably allocate unique addresses to each of the slave nodes. However, according to an embodiment, the control algorithms implemented in the master node require that any data received at the master node from the slave nodes is synchronised or at least sampled at a determinable time. This is so that any node address changes can be determined and monitored by the master node over time and so that there is agreement across the system on the data relating to a particular time and condition of the system. In order to achieve this, a slave node may synchronise its internal sampling cycle to the start of a data cycle that the master node initiates. This can be done, for example, by the slave node using a phase lock loop to synchronise to the start of the data cycle.

In the described embodiments each slave node receives data into its processor from upstream on the transmit line. The slave node only connects its upstream transmit line to its downstream transmit line when the slave node has had an address allocated to it. The receive line may be used for synchronised message returns and time multiplexed data returns. Each slave node receives data from downstream on the receive line, adds its own data via the adder and sends the combined data upstream.

According to an embodiment, when the master node sends a message addressed to a particular slave node (as opposed to a broadcast message on the default slave address), the reply message which the master node receives in response will contain data from the addressed node and also data from the furthest upstream slave node in the network, if the addressed slave node is different to the furthest upstream node. Because the reply received at the master node can include data from more than one slave node, no two slave nodes should add data to the reply message simultaneously. Instead, according to an embodiment, the slave nodes time slice their respective data sets into the reply message on the receive line so that the master node can distinguish between the respective data sets when reading the reply message.

In the described embodiments, the or each slave node is shown as including an “adder” for adding information relating to its respective slave node onto the receive line and for transmitting data from downstream slave nodes towards the master node. According to an embodiment, the adder in a slave node comprises a controlled OR gate. The OR gate enables the respective slave node to choose between placing data on the receive line or placing no data and instead allowing the next slave node to control the receive line and, if appropriate, add data thereto.

The method of node address allocation described herein is reliable and efficient. It is fully scalable and therefore is effective for both large and small networks.

The method supports serial networks. This advantageous since, in practice, a communication link may be only one of several connections required between terminals or nodes of a network. Often nodes or terminals will also require connection for measurements to be taken and analogue measurements signals to be transmitted, for which serial connections are required.

A computer such as a general purpose computer can be configured or adapted to perform the node address allocation described herein. In one embodiment the computer comprises a processor, memory and a display. The computer may also comprise one or more input devices such as a mouse and/or keyboard.

A computer readable medium such as a carrier disk or carrier signal having computer executable instructions adapted to cause a computer to perform the described method or methods of node address allocation may be provided.

Particular embodiments have been described herein by way of example only. It will be appreciated that variation of the described embodiments may be made.

What is claimed is:

1. A method for allocating node addresses in a computer network architecture comprising at least one master node and at least one slave node serially connected downstream of the master node, the or each slave node including a switch for connecting an upstream transmit line with a downstream transmit line at the slave node such that, when the switch is open, the master node and any upstream slave nodes are not connected via the transmit line to any downstream slave nodes and, when the switch is closed, the master node and any upstream slave nodes are connected via the transmit line to any downstream slave nodes, wherein, before the method is performed: at least one of the slave nodes has not yet been allocated a unique slave address; any slave nodes not yet allocated a unique slave address share a default slave address; and the switch in any slave node having the default slave address is open, the method comprising the steps of:
a) the master node sending a message on the default slave address;
b) the furthest upstream slave node having the default slave address being allocated a unique slave address;
c) the slave node allocated the unique slave address at step b) closing the switch connecting the upstream transmit line with the downstream transmit line, so as to connect the master node and any upstream slave nodes to any downstream slave nodes;
d) the slave node allocated the unique slave address at step b) sending an acknowledgement to the master node; and
e) repeating steps a) to d) until there are no remaining slave nodes having the default slave address.

2. The method of claim 1, wherein the message includes an instruction to allocate the unique slave address to the message recipient and step b) comprises the furthest upstream slave node having the default slave address actioning the message.

3. The method of claim 1 further comprising, after step a), the step of the furthest upstream slave node having the default address acknowledging the message.

4. The method of claim 1, wherein step c) is performed automatically after the slave node has been allocated the unique slave address at step b).

5. The method of claim 1, wherein the message includes an instruction to connect the upstream transmit line at the message recipient with the downstream transmit line at the message recipient, after the slave node has been allocated the unique slave address.

6. The method of claim 1, wherein step c) is performed in response to a second message from the master node.

7. The method of claim 1, wherein step e) comprises the master node periodically checking if there are any further slave nodes having the default slave address.

8. The method of claim 1 wherein, before the method is performed, all slave nodes have not yet been allocated unique slave addresses.

9. The method of claim 1 wherein, before the method is performed, at least one of the slave nodes has already been allocated a unique slave address.

10. A computer network architecture comprising:
at least one master node;
at least one slave node serially connected downstream of the master node; and
a transmit line connecting the at least one master node and the at least one slave node, the transmit line for communication in the downstream direction;
wherein each slave node includes a switch for connecting the upstream transmit line with the downstream transmit line at the slave node;
wherein the computer network architecture is arranged such that, when a slave node has not yet been allocated a unique slave address, the slave node takes a default slave address common to all slave nodes not yet allocated unique slave addresses, and the switch in the slave node is open such that the master node and any upstream slave nodes are not connected via the transmit line to any downstream slave nodes, and when a slave node has been allocated a unique slave address, the switch in the slave node is closed such that the master node and any upstream slave nodes are connected via the transmit line to any downstream slave nodes.

11. The computer network architecture of claim 10, further comprising a receive line connecting the at least one master node and the at least one slave node, the receive line for communication in the upstream direction.

12. The computer network architecture of claim 11, wherein the or each slave node further comprises an adder connected to the receive line.

13. The computer network architecture of claim 10, wherein the or each slave node further comprises a processor connected to the transmit line for receiving and processing data from the master node.

14. A computer network architecture for carrying out the method of any of claim 1.

15. A computer readable medium having computer-executable instructions adapted to cause a computer network architecture to perform the method of any of claim 1.

16. A slave node for the computer network architecture of any of claim 10.
